(19) United States
(12) Patent Application Publication
(10) Pub. No.: US 2009/0205111 A1
(43) Pub. Date: Aug. 20, 2009

(54) Combination Insulating Beverage Holder and Headgear

(76) Inventor: Richard L. Beard, Portland, ME (US)

Correspondence Address: BOHAN MATHERS, PO BOX 17707, PORTLAND, ME, 04112-8707, US

(21) Appl. No.: 12/032,352

(22) Filed: Feb. 15, 2008

(51) Int. Cl. A42B 1/24; A47J 41/00; A42B 1/00; B65D 25/00

(52) U.S. Cl. 2/209.13; 220/592.16; 220/592.25; 220/739; 2/195.1

(57) ABSTRACT

Insulating beverage holder that can be fitted and carried inside a baseball cap. The insulating holder has a body made of a sheet of insulative fabric, with fasteners along fabric sides of the body. Fasteners are zip-lock strips or touch-fastener strips. The body is folded together and the sides fastened together to form a cup. The body, when opened out, fits inside a conventional baseball cap. The upper edges of the body can be tucked behind a finish edge on the cap, to hold the insulating holder body in place, even when the cap is removed from the head. The insulating holder may incorporate a strap for holding a bottle opener. The beverage holder may also be mounted on the outside surface of the baseball cap. Mating fastener strips are provided on the outside surface, which allow the body to be easily attached to or removed from the cap.

### BACKGROUND INFORMATION

1. Field of the Invention

The invention relates to the field of insulating beverage holders. Furthermore, the invention relates to headgear that carry insulating beverage holders.

2. Description of the Prior Art

Insulated beverage cups or sleeves for holding cooled beverages are widely used. The conventional insulated cup is a container made of an insulating material that serves to keep the beverage cold or warm, as the case may be. Some insulated cups are constructed as a plastic or metal double-walled container, with insulative material or an air space between the two walls. Others are single-walled constructions, formed of a foam material. Some are made of a flexible foam fabric, so that they do not take up much space and, thus, can be stored in a relatively small space when not in use, such as in a pocket.

One disadvantage of the conventional insulated cup is that it is an additional article that a person has to remember to pack and carry around. What is needed is an insulating holder for a beverage container that is incorporated into another article of gear or wear that a person frequently wears, particularly for recreational outdoor activities, so that the person automatically carries the insulating holder with him or her, when wearing the article of gear or wear.

### BRIEF SUMMARY OF THE INVENTION

The invention is an insulating beverage holder for a beverage container, that is incorporated into an article of headgear, such as the conventional baseball or feed cap, or other type of headgear. The insulating beverage holder, also referred to hereinafter interchangeably as a “cooly cup”, is made of a flexible foam fabric and, in its stowable state, is simply a flat piece of fabric. Fastening means are provided on the appropriate side edges of the cooly cup, such that the cup may be assembled into a cup form quickly and easily, ready to receive a beverage in a conventional size container, be it a bottle or a can.

The fabric of the cooly cup is flexible and compressible and fits within the inside of the headgear. Baseball caps typically have a finish edge around the perimeter of the cap that is folded inward to the inside of the cap. This edge may be of the same fabric as that of the cap itself, or may be a tape. This finish edge is stitched to the edge of the cap, to provide a finished look to the cap and also to reinforce the shape-holding property of the fabric of the cap.

The cooly cup according to the invention is dimensioned to fit inside the baseball cap. The edges of the cooly cup extend to the edge of the cap and are tucked inside the finish edge. This finish edge provides sufficient holding power to ensure that the cooly cup remains in the baseball cap, even when the cap is removed from the head. The cooly cup according to the invention may also be affixed to the outside surface of a baseball cap.

The fabric of the cooly cup is thin enough and flexible enough, so as to generally conform to the overall shape of the cap and not interfere with the fit of the cap. Indeed, the cooly cup fitted into the baseball cap is unobtrusive, as if it were a padded lining, and feels comfortable against the head, and may even provide some insulation against cold temperature.

Various commonly used fastening means may be used on the side edges of the cooly cup. One such fastening means includes strips of touch-fastener fabric, that is, fabric hook-and-loop fasteners. A more elegant fastening means is a zipper-like closure, similar to ones used on plastic food storage bags. The fastening means may be a mating groove and bead mechanism that is sealed or opened with a slide, or simply pressed together and pulled apart. These fasteners have advantages in that they are not bulky, are flexible enough to allow the cooly cup to be inserted into the inside or fitted onto the outside of a baseball cap. They are affixable to the foam fabric by means of heat-welding. They are commonly used on products in everyday use, so the user of the cooly cup will readily understand how to fasten the sides of the cup together. Of course, other fasteners, such as snaps, buttons and loops, etc. may also be suitable, depending on the intended affect of the fasteners. For example, it may be desirable to use highly decorative buttons or snaps, for aesthetic appeal.

Assembly and use of the cooly cup is quick and simple. A wearer, who wishes to use the cooly cup, simply pulls the cooly cup from the cap, folds it together and fastens the sides.

A suitable foam fabric for the cooly cup is a foam sheet fabric that is laminated with a jersey-knit fabric, commonly known as “scuba foam.” Other suitable insulating fabrics may also be used. A suitable fabric is one that is flexible enough to stow on the inside or outside of a baseball cap or other type of headgear, to which fastening means may be securely affixed.

A further addition to the cooly cup according to the invention is a bottle opener of the type disclosed in U.S. patent applications Ser. Nos. 11/656,683, and 11/749,593, filed by the inventor of this present application on Jan. 23, 2007, and May 16, 2007, respectively. The subject matter of these two applications is incorporated herein by reference, in its entirety. A strap band may be attached to the body of the cooly cup. This may be accomplished in a variety of ways. For example, a pair of parallel slits may simply be cut into the cooly cup to form a strap for receiving and holding the bottle opener. Alternatively, a strap of the same material or of a different material may be affixed to the body of the cup. For example, a leather strap may be snapped or riveted or stitched to the body. The advantage of using the bottle opener disclosed in the cited patent applications is that this bottle opener is curved to accommodate the natural curvature of the human head. Thus, it can remain inserted in the fabric of the cooly cup and, even when the cooly cup has been opened up, i.e., unfastened, and inserted into the inside of the baseball cap. The bottle opener will remain comfortably fastened to the cooly cup inside the baseball cap.

### BRIEF DESCRIPTION OF THE DRAWINGS

The present invention is described with reference to the accompanying drawings. In the drawings, like reference numbers indicate identical or functionally similar elements. The drawings are not to scale.

FIG. 1 is a plane view of the cooly cup according to the invention, opened out flat.

FIG. 2 is a perspective view of the cooly cup assembled, ready for use as an insulating container for a beverage, also showing a bottle opener inserted into a strap.

FIG. 3 is a cross-sectional view of a preferred embodiment of the fastening means.

FIG. 4 shows the cooly cup of FIG. 1, opened up and placed into a baseball cap for storage.

FIG. 5 illustrates the cooly cup of FIG. 1 that is adapted to complement the design or look of the baseball cap and is carried on the outside of the cap.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

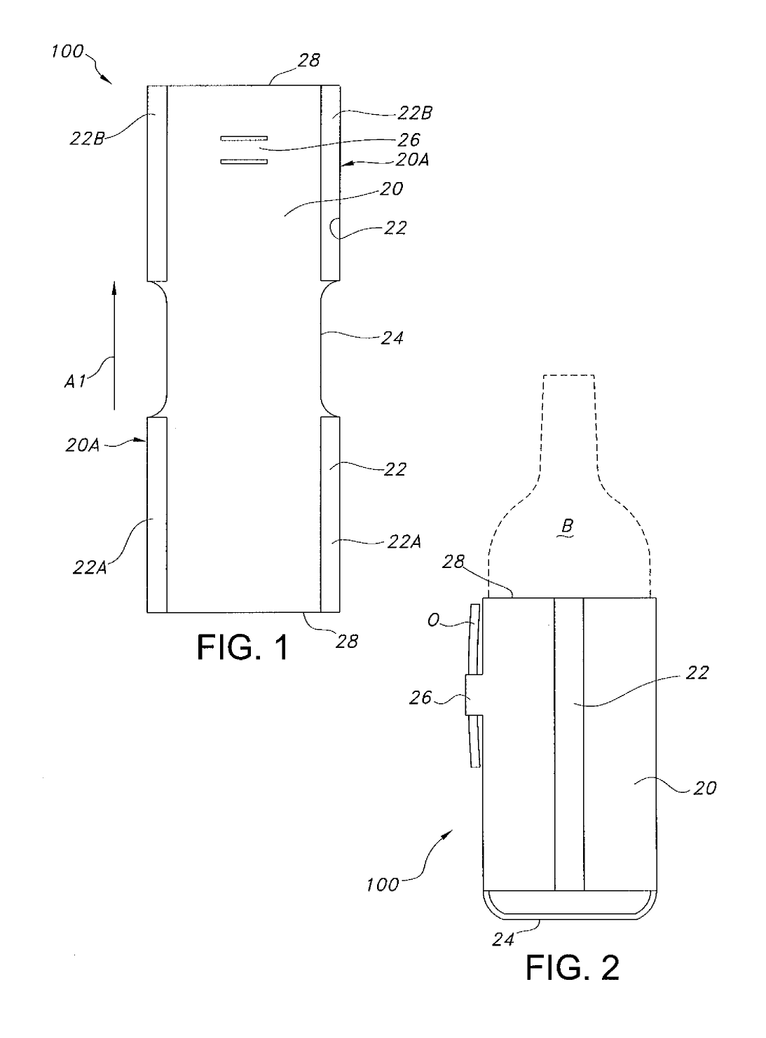

FIG. 1 shows a plane view of a preferred embodiment of a insulating beverage holder, also called a cooly cup 100 according to the invention, opened out flat. FIG. 2 shows the cooly cup 100 in its functional, ready-to-use state. The cooly cup 100 comprises essentially a fabric body 20. A fastener 22 is provided along the side edges 20A of the body 20. Optionally, a strap 26 may be provided in the body 20 to accommodate a bottle opener O. The strap 26 is may be an integral part of the fabric body 20. For example, the strap is formed by making two parallel cuts in the fabric body 20. The strap 26 may also be separate component that is affixed in some manner to the body 20. For example, the strap 26 may be made of leather or a plastic material that is stitched, riveted, snapped, or adhesively affixed to the body 26. The cooly cup 100 is made functional simply by folding the body 20 so that upper edges 28 of the cup are at approximately the same level and fastening the fastener 22 at the side edges 20A. A cup bottom 24 has a cut-out on the sides to reduce bulkiness.

Preferably, the body 20 is constructed of a flat piece of insulative fabric, such as, for example, a fabric commonly used for insulating sleeves for beverage containers, and referred to as “scuba foam.” This fabric is a laminated construction of an open-celled neoprene foam and a jersey knit fabric, and is commercially available in various thicknesses.

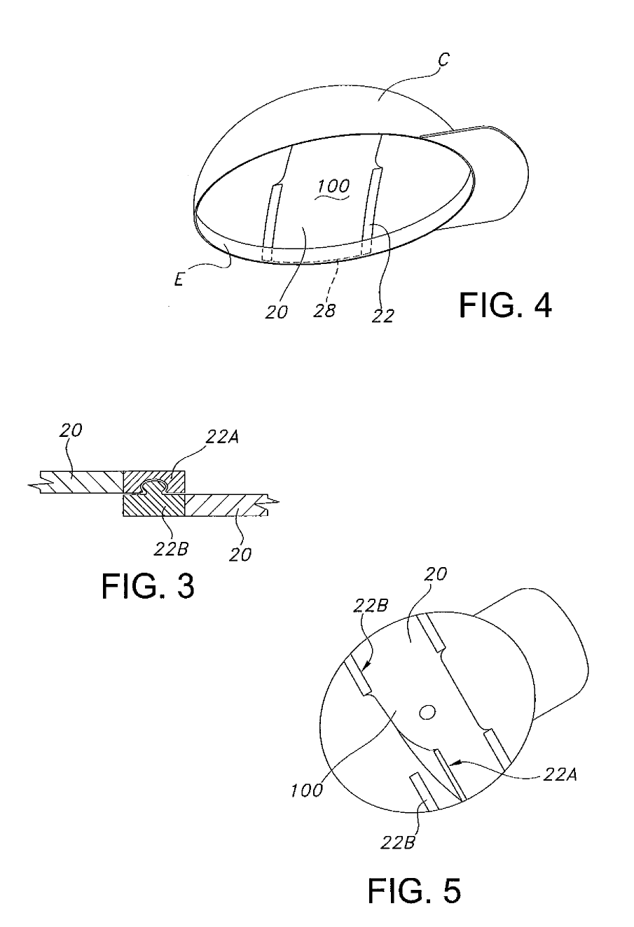

FIG. 3 is a cross-sectional illustration of one example of the fastening means 22. A very suitable fastener 22 is a bead-and-groove zipper, often referred to as a “zip lock”, such as is commonly used on food-storage bags. Such zip locks have two mating profiles, a first flexible profile 22A that includes a groove and a second flexible profile 22B that includes a bead. The flexible profiles are extruded from a polymeric material. In the example shown, the fastener is what is referred to as a top lock zip lock. The user folds the body 20 in the direction of an arrow A1 shown in FIG. 1 to bring the two upper edges 28 in alignment with each other. This automatically aligns the two flexible strips 22A and 22B, which the user now simply presses together to force the bead into the groove. To open the fastener, the user simply pulls the two strips 22A and 22B apart. Myriad variations of the bead-and-groove zippers are known and commercially available. Some have sliders that lock the bead profile into the groove profile. Any of these types of zip locks may be suitable for use with the cooly cup according to the invention, as long as the flexible profiles 22A and 22B are flexible enough to allow the cooly cup 20, when is it opened out, to be inserted into a baseball cap.

Use of zip lock profiles as the fastener 22 also enables the cooly cup 20 to be assembled on the outside of a baseball cap. In this case, mating first or second flexible strips of the zip lock fastener 22 are also incorporated into the outer surface of the baseball cap. The cooly cup 100 will have the first flexible profile 22A on two parallel sides and the second flexible profile 22B on the two parallel sides at the other end of the body 20, as shown in FIG. 1. A baseball cap that is adapted to receive the cooly cup 100 will also have pairs of the first flexible profile 22A and the second flexible profile 22B attached to it. These flexible profiles are placed on the cap, such that they mate with the corresponding mating profiles on the body 20 of the cooly cup 100, which can then be simply pressed into place on the cap or pulled off, as needed.

Another suitable fastener 22 is a touch-fastener strip, i.e., a fabric hook-and-loop fastener, that is provided along the side edges 20A. Other types of suitable fasteners include snaps, hook-and-eye fasteners, ties, buttons and loops, flexible zipper-type fasteners, etc. Ideally, the fastener 22 is a mechanism that requires little effort to fasten the two parts of the body 20 together and is also not bulky. The fastener 22 has to be flexible enough to allow the body 20 to be inserted into the inside of a baseball cap, without the fastener 22 causing discomfort to the wearer or distorting the shape of the cap.

FIG. 4 shows the cooly cup 100 opened up and inserted into a cap C. The upper edge 28 of the body 20 is tucked behind an edge E of the cap C.

FIG. 5 illustrates the cooly cup 100 fastened to the outside of the baseball cap C. A part of the body is folded away, to expose the second flexible profile 22B that is provided on the cap C and the first flexible profile 22A on the body 20.

It is understood that the embodiments described herein are merely illustrative of the present invention. Variations in the construction of the insulating holder may be contemplated by one skilled in the art without limiting the intended scope of the invention herein disclosed and as defined by the following claims.

What is claimed is:

1. An insulating holder for holding a beverage container, said insulating holder comprising:
a body constructed of a sheet of fabric said body having a first end and a second end, said first end and said second end each having two side edges and an upper edge, and a bottom connecting said first end with said second end; and
a fastener that is provided along said side edges, said fastener including a pair of first fastener elements along said two sides of said first end of said body and a pair of second fastener elements along said two sides of said second end, said first fastener elements releasably and matingly connectible with said second fastener elements;
wherein said body is stored in a non-operative state opened out, without said first fastener elements engaging said second fastener elements.

2. The insulating holder of claim 1, wherein said body is made of an insulative fabric.

3. The insulating holder of claim 2, wherein said body is made of a laminated construction of an open-cell foam and a jersey knit fabric.

4. The insulating holder of claim 1, wherein said fastener is a reclosable zip-lock fastener.

5. The insulating holder of claim 1, wherein said fastener is a reclosable touch-fastener.

6. The insulating holder of claim 4, wherein said fastener is a reclosable button-and-loop fastener.

7. The insulating holder of claim 1, further comprising a strap in said body for holding a bottle opener.

8. The insulating holder of claim 7, wherein said strap is an integral part of said body.

9. The insulating holder of claim 7, wherein said strap is affixed to said body.

10. Headgear kit comprising:
a headgear having an outer surface; and
an insulating holder for holding a beverage container, said insulating holder having a fabric body constructed of a sheet of fabric, said body having a first end and a second end, said first end and said second end each having two side edges and an upper edge, and a bottom connecting said first end with said second end; and
a fastener that is provided along said side edges, said fastener including a pair of first holder fastener elements along said two sides of said first end of said body and a pair of second holder fastener elements along said two sides of said second end, said first holder fastener elements mating with said second holder fastener elements;
wherein said headgear has a pair of first headgear fastener elements and a pair of second headgear fastener elements disposed on said outer surface, so as to matingly and releasably receive said pair of said first holder fastener elements and said pair of said second holder fastener elements.

11. The headgear kit of claim 10, wherein said headgear has finish edge that extends into said inside of said headgear, and wherein said insulating holder is constructed of a flexible insulative fabric and said upper edges are tuckable behind said finish edge of said headgear.

12. The headgear kit of claim 10, wherein said insulating holder is constructed of a laminated fabric comprising an open-cell neoprene foam layer and a layer of jersey knit fabric.

13. The headgear kit of claim 10, wherein said fastener is a reclosable zip-lock fastener.

14. The headgear kit of claim 10, wherein said fastener is a reclosable touch-fastener that is applied to said side edges.

15. The headgear kit of claim 10, wherein said fastener is a reclosable button-and-loop fastener.

16. The headgear kit of claim 10, further comprising a strap incorporated into said body, for holding a bottle opener.

17. The headgear kit of claim 11, wherein said strap is an integral part of said body.

18. The headgear kit of claim 11, wherein said strap is affixed to said body.
